(19) United States
(12) Patent Application Publication
(10) Pub. No.: US 2002/0014555 A1
(43) Pub. Date: Feb. 7, 2002

(54) Method for altitude control and/or pitch angle control of airships, and an airship having a device for altitude control and/or pitch angle trimming

(76) Inventor: Tim Smith, Teupitz (DE)

Correspondence Address: JORDAN AND HAMBURG LLP, 122 East 42nd Street, New York, NY, 10168, US

(21) Appl. No.: 09/790,792

(22) Filed: Feb. 22, 2001

(30) Foreign Application Priority Data
Feb. 23, 2000 (DE) 10008448.6
Mar. 10, 2000 (DE) 10011319.2

(51) Int. Cl. B64B 1/34; B64B 1/02; B64B 1/06

(52) U.S. Cl. 244/26

(57) ABSTRACT

A method for altitude control of airships in all the speed ranges which occur during operation has the following features:

a) above a predetermined upper speed threshold value, the altitude of the airship is essentially controlled by at least one elevator (5);

b) in the range between the upper speed threshold value and a predetermined lower speed threshold value, the altitude of the airship is controlled by aerodynamic lift or downward force which can be varied independently of the airspeed and incidence angle and is produced by aerodynamic lifting bodies; and

c) below the lower speed threshold value, the altitude of the airship is controlled by means of devices which produce vertically acting thrust.

An airship which is suitable for carrying out the method has a fuselage, forward propulsion means and aerodynamic lifting bodies for producing aerodynamic lift bodies for producing aerodynamic lift which, above a lower threshold value of the airspeed, can be varied independently of said airspeed and independently of the incidence angle, and can be influenced by means of a control device.

The invention relates to a method for altitude control and/or pitch angle trimming of airships. It also relates to an airship having a device for altitude control and/or pitch angle trimming.

It is known that the aerostatic lift of an airship is subject to considerable fluctuations during operation as a result of external factors which can be influenced only to a limited extent. Furthermore, the airship weight varies during operation, for example as a result of fuel consumption. These changes influence the force and moment equilibrium of the airship, and have to be corrected by means of specific measures. Furthermore, it is essential to be able to influence the force and moment balance to an adequate extent in order to influence the flightpath of an airship in a controlled manner and for attitude and direction correction in response to external disturbances, for example due to wind influences.

The prior art is that this is generally done by varying the aerodynamic lift of the airship as a function of the airspeed and incidence angle. To this end, the pitch angle (angle about the lateral axis of the airship) of the airship is varied by control-surface deflection on the horizontal stabiliser surfaces which are normally located at the rear of the airship, so that the airship fuselage as an entity produces aerodynamic lift or downward force from the change in incidence angle resulting from this. In consequence, this leads to the fuselage of the airship also experiencing increased aerodynamic drag. In this case, care must be taken to ensure that this type of aerodynamic control of the airship operates only above a specific speed, which depends on the distance between the center of lift and the center of gravity, on the aerodynamic efficiency (gliding angle) of the airship fuselage and the distance to the horizontal stabiliser surfaces (moment lever), and is typically about 60 km/h for large semidirigible airships. At this limiting speed, it is no longer possible to influence the flightpath of the airship by elevated deflection and the change in the incidence angle of the airship fuselage associated with this, that is to say the airship can no longer be controlled aerodynamically. Below this speed, since the aerodynamic airship fuselage lift is then too low, since the downward force on the elevator is then greater than the aerodynamic lift from the airship fuselage, and/or since the fuselage lift resultant moves horizontally to the rear, the overall moment balance about the airship lateral axis is reversed, and the effect of the elevator is thus also reversed. At relatively low airspeeds this therefore leads in the worst case to a considerable limitation or to a loss of controllability of the airship. Furthermore, a change in the center of gravity position in the longitudinal direction is worthwhile to vary the steady state of the pitch angle (trimming), and this is done by retrimming the ballast, fuel, or balloon filling, but is dependent on there being an appropriate system on board and thus increases the design complexity and the weight of the airship. Particularly in the case of relatively large airships, this method is associated with difficulties, which increase with the airship size, as a result of the changing relationships between the forces which can be produced aerodynamically, the aerostatic lift and the vertical center of gravity position.

It is known for an additional force to be produced in the desired direction by the use of thrust-producing systems such as propellers, turbine engines or propulsion units. For example, DE-A 197 00 182 describes thrust vector control for an airship, which comprises a number of propeller thrust devices whose propeller hubs can be pivoted about the lateral axis. DE-A 23 18 022 describes a transport aircraft having bodies which produce aerostatic lift, which aircraft has a large number of vertically acting propeller thrust devices in order to assist the other lift-producing means. WO 80/00825 describes airship control by means of shrouded propellers which are installed in the fuselage, act vertically and are also intended to allow the airship to be controllable in the lower speed range in particular. The disadvantage of these devices is of the design complexity and their additional weight are very high particularly since, in the event of failure of these systems, the overall control of the airship would fail, and a high level of complexity is therefore required for system redundancy. These devices are also associated with high energy consumption, and thus high fuel consumption and greater noise emissions, particularly at relatively high speeds. With thrust control devices such as these, care must also be taken to ensure that their effectiveness and response speed are limited, in particular in the medium and high speed range, since the aerodynamic forces then become greater.

It is furthermore known for wings and control surfaces to be fitted in order to influence the production of aerodynamic lift by the airship by varying the pitch angle and as a result of the change in the incidence angle resulting from this. For example, DE A 25 07 514 describes a hybrid airship which uses wings with a small extent to ensure the equilibrium of forces in the vertical direction and thus makes it unnecessary to use ballast, to release lifting gas or to use exhaust gas water recovery systems, and which improves the manoeuvrability. The problem in this case is that this system operates only at high speeds, a specific speed must be maintained accurately for horizontal flight as a function of the aerostatic lift and the weight of the airship, and, as with an aeroplane, a runway is required for takeoff and landing. In this case, at a constant speed, the lift force can be varied only by varying the airship pitch angle, and is thus associated with an increase in the aerodynamic drag. This can be avoided only by using a Canard wing (Canard stabiliser surfaces) although, in consequence, the longitudinal stability of such airships in flight is poorer.

Furthermore, the prior art also covers the production of aerodynamic lift in the desired manner being assisted by varying the shape of the airship. For example, a hybrid dirigible airship is known from EP 0 861 773 which, in addition to wings, has a discus-shaped fuselage which, in a similar way to a wing, produces aerodynamic lift at relatively high speeds. However, this is associated with the same disadvantages as those with the abovementioned airships with wings and, furthermore, the necessity for complex shaping of the airship fuselage also results in a large number of design problems with regard to the structure and weight.

The object on which the invention is based is, in consequence, to adequately influence the force and moment balance of the airship in all the speed ranges that occur, while maintaining a high level of system reliability, with little change to the airship pitch angle and with as little additional power as possible being required for altitude control of the airship without, in the process, influencing the overall operational behaviour or the airship configuration with regard to maintaining an optimum and high airspeed. The aim is to satisfy the requirement for financial economy of such an altitude control method and of the corresponding airship in terms of operation, maintenance and design complexity.

This object is achieved by the method according to claim 1 and by the airship according to claim 6. For the method according to the invention for altitude control of airships, it is thus important to be able to influence the force and moment balance of the airship in three ways, namely via a—conventional—elevator, via vertical thrust-producing devices, and by means of aerodynamic lifting bodies, which produce aerodynamic lift or downward force which can be varied independently of the airspeed and incidence angle. In this case, each of the three means is used in a specific speed range. It shall be particularly stressed in this case that, within the speed range in which there are problems in using elevators to control the altitude of the airship (see above), a further distinction is drawn between a first, lower speed range, in which altitude control is carried out by means of devices which produce vertical thrust, and a medium speed range in which aerodynamically acting lifting bodies are used for altitude control, whose lift or downward force can be varied independently of the airspeed and incidence angle. Overall, airships which are controlled using the method according to the invention are distinguished by excellent manoeuvrability with high reliability and good resistance to failures. Furthermore, when the method according to the invention is in use, the corresponding airship can come to a stop in the air, contrary to the situation with hybrid airships of the type described in DE 25 07 514 A1. This of critical importance for many typical areas in which airships are used and operated, for example the transportation of bulky goods over inaccessible terrain.

In other words, when the present invention is in use, at least one aerodynamic lifting body, which is arranged at a sensibly chosen position on the airship, that is to say at a distance from the center of lift, produces aerodynamic lift or a downward force, which can be varied independently of the airspeed and incidence angle, above a minimum speed, by means of specifically selected additional devices.

A first preferred development of the present invention is distinguished in that a number of aerodynamic lifting bodies are provided for producing aerodynamic lift or downward force which can be varied independently of the airspeed and incidence angle, to be precise being a range distributed in the longitudinal direction of the airship. A tandem arrangement of the relevant lifting bodies in front of and behind the center of gravity of the airship is particularly preferable in this case. As will be described in greater detail further below, this assists the manoeuvrability of the airship.

Depending on the design of one or more lifting bodies which are distributed in the longitudinal direction for producing aerodynamic lift or downward force which can be varied independently of the airspeed and incidence angle, the lift or downward force of these lifting bodies can be varied in conjunction with the stabiliser surfaces with elevators which are provided even on conventional airships. If the design includes a number of lifting bodies distributed in the longitudinal direction, the total pitch moment can be influenced independently of the aerostatic lift force by appropriate variation of the aerodynamically produced lift or downward force from the lifting bodies which are distributed in the longitudinal direction. In the high speed range, which typically occurs at speeds of more than about 70 km/h with a large airship, the altitude of the airship is in this case sensibly controlled essentially by the elevator, since this requires less energy. The aerodynamic lift, which can be varied independently of the airspeed and incidence angle, can in this case be used, if required, for pitch angle trimming, that is to say for steady-state adjustment of the pitch angle. In the medium speed range, which typically occurs at speeds between about km/h and about 70 km/h for a large airship, both the altitude control and the pitch angle trimming of the airship are sensibly carried out by means of the aerodynamic lift or downward force which can be varied independently of the airspeed and incidence angle since there is one speed in this speed range at which the flight path of the airship cannot be influenced by elevated deflection and below which the elevator deflection effect is reversed (see above). In the low speed range, in which the effect of the aerodynamic lift which can be varied independently of airspeed and incidence angle is no longer sufficient for reliable altitude control and pitch angle trimming, and which typically occurs at speeds below about 40 km/h for a large airship, the altitude control and pitch angle trimming of the airship are sensibly carried out by means of vertically acting, thrust-producing devices which, in this speed range, are used as alternatives to or in addition to the lifting bodies which produce aerodynamic lift and can be varied independently of the airspeed and incidence angle. The advantages of this method are that the force and moment balance of the airship can be influenced in an effective and energy-saving manner with only a minor change to the airship pitch angle and in all speed ranges; the controllability of the airship is achieved in a simple manner at all speeds; and there is also no need for any weight trimming system. The minor change to the airship pitch angle firstly has the advantage that a relatively minor change to the incidence of the airship fuselage means that the aerodynamic drag and thus the energy consumption are reduced and, secondly, it is particularly important for cargo airships for the airship pitch movement to be small since the forces which act from the freight in the longitudinal direction of the airship on the airship structure are reduced. The method inherently results in the airship control being highly reliable since, in the event of failure of the vertically acting propellers or the aerodynamic lift system, the respective other system can in each case take over the majority of the lift and control function, thus meaning that there is no need for any further redundant systems.

In one expedient embodiment of the invention, the lifting bodies which produce aerodynamic lift are in the form of wings. In a particularly preferred manner, these wings may also contain further devices and structural elements of the airship such as forward propulsion elements and the vertically acting, thrust-producing elements by which means the financial economy of airship maintenance is improved due to the capability to replace the entire propulsion and manoeuvring unit block as a module.

It is in this case advantageous to produce and to vary the aerodynamic lift by influencing the circulation around the wing aerofoil section, which expediently has an elliptical or similar shape. This may be done in particular by blowing air out at suitably selected positions, for example by blowing compressed air out of slots, holes or other blowing openings in the rear aerofoil section with regard to the airflow. Blowing compressed air out on either the upper surface or the lower surface of the wing influences the circulation around the profile, that is to say the rear stagnation point (Kuttapoint) is moved forwards on the aerofoil section side opposite the blowing-out point. The fluid flow diverted in this way produces an impulse force laterally with respect to the incident flow direction onto the wing and this force—depending on the point of which the air is blown out—results in a lift or downward force. The advantages of aerodynamic lift production by circulation control over classical methods (curved aerofoil section, leading-edge flaps (slats) curved flaps etc.) is that the lift force can be varied independently of the airspeed and incidence angle, above a minimum speed, but this lift force is produced even at very low speeds, and that the lift force produced in this way is very large. Commercially available compressors, for example, may be used as the compressed air source. The magnitude of the aerodynamic lift or downward force can be varied by varying the compressed air pressure and thus the flow rate at which the air is blown out, and the lift distribution can be varied by varying the diameter of the compressed air pipeline across the wingspan.

In one particularly preferred development of the invention, the vertically acting, thrust-producing elements may be in the form of shrouded propellers integrated in the wings, whose upper and lower openings can be closed by folding or sliding covers in order in this way to avoid any disturbance to the flow around the wing aerofoil section when lift is being produced on the wings by means of circulation control.

Furthermore, one expedient development is to additionally use the known concepts for influencing the lift from wings, such as control flaps, leading-edge flaps (slats), enlarging the lift area, or a combination of these concepts.

Although the above statements refer to the use of the lifting bodies which are suitable for producing lift or a downward force which can be varied independently of the airspeed and incidence angle, possibly in conjunction with further devices for controlling the altitude of the airship, the present invention is not limited to this. In fact, applications are also conceivable in which those lifting bodies may be used in conjunction with further device just for trimming the airship. In this context, reference is made to claim 18.

The present invention will be explained in more detail in the following text with reference to a preferred exemplary embodiment which is illustrated in the drawing, in which:

FIG. 1 shows a perspective view of an airship according to the present invention,

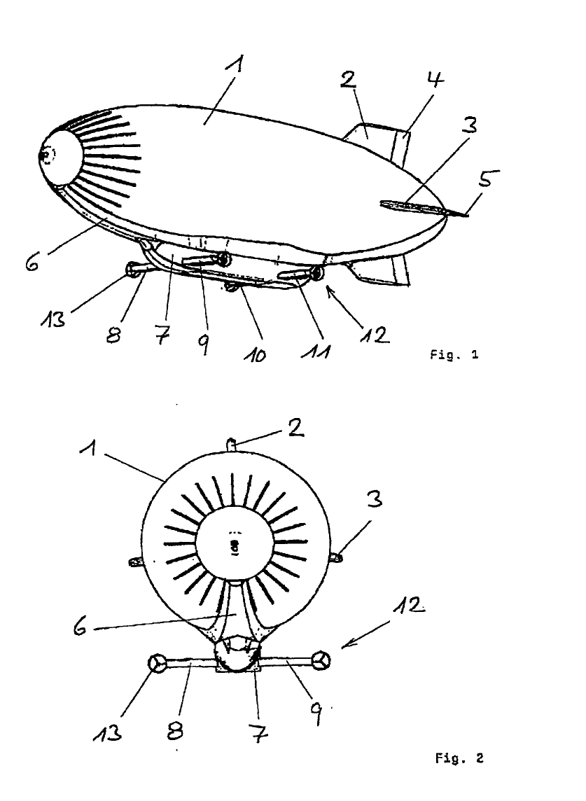

FIG. 2 shows the airship from FIG. 1 from the front,

FIG. 3 shows a perspective view of a wing used for the airship shown in FIGS. 1 and 2,

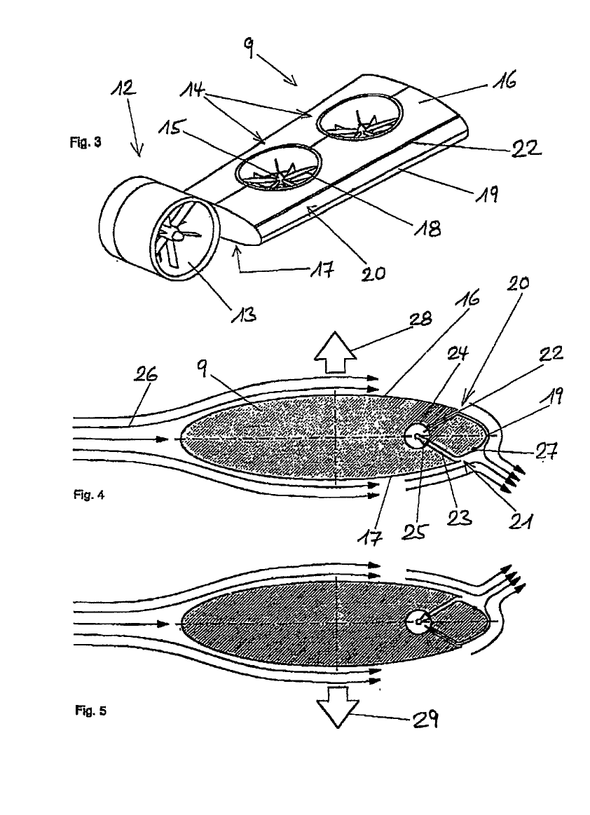

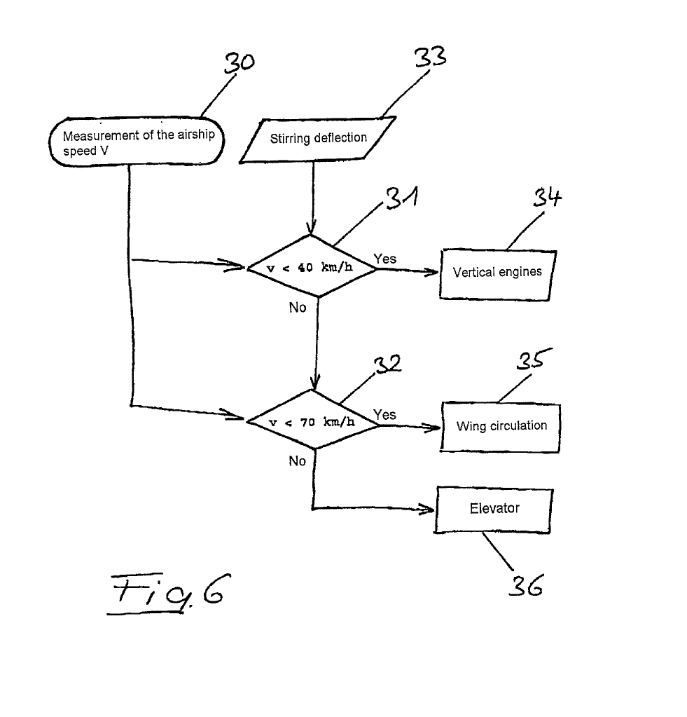

FIG. 4 shows a cross section through the wing shown in FIG. 3, in the lift configuration,

FIG. 5 shows a cross section through the wing shown in FIG. 3, in the downward force configuration,

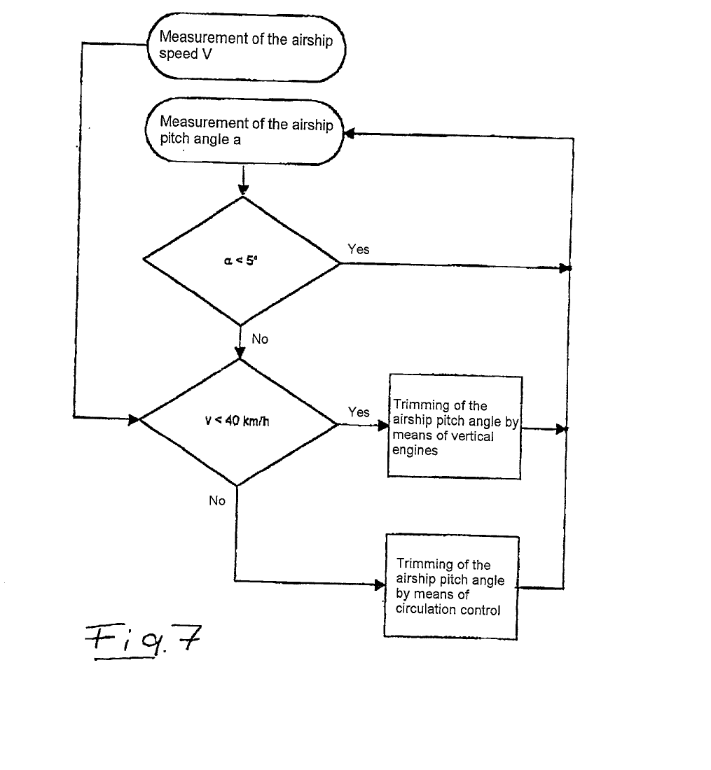

FIG. 6 shows a flowchart of the control unit which is used for flight path control of the airship shown in FIGS. 1 to 5, and

FIG. 7 shows a flowchart of a control unit which is used for trimming the lateral access of an airship

The airship illustrated in the drawing comprises a fuselage 1 with vertical stabiliser surfaces 2 and horizontal stabiliser surfaces 3 arranged at the tail. The vertical stabiliser surfaces 2 in this case have associated rudders 4, and the horizontal stabiliser surfaces 3 have associated elevators 5.

The fuselage 1 is produced using the structure which is known per se. A keel 6 is arranged on it, extends over virtually the entire length of the fuselage 1, and supports a load carrying gondola 7. To the extent described above, the airship illustrated in the drawing corresponds to the prior art which has been known for a long time, so that no further explanation is required.

Two wings 8, 9, 10, and 11 project on either side of the load carrying gondola 7, and are rigidly connected to the load carrying gondola 7. In this case, the two front wings 8 and 9 are arranged in front of the center of lift, and the two rear wings 10 and 11 are arranged behind it. Forward propulsion elements 12 in the form of shrouded propellers 13 are arranged at the ends of the wings 8 to 11. The horizontal thrust which is provided by these propellers 13 and is used to move the airship in the forward direction is transmitted to the load carrying gondola 7 via the wings 8 to 11.

FIG. 3, which shows the front port wing 9 viewed in perspective obliquely from the rear and from above, shows further details of the design of the wings. For example, two devices 14 which produce vertical thrust and are in the form of shrouded propellers 15 are integrated in each of the four wings. The openings 18 which are arranged on the upper surface 16 and the lower surface 17 of the wings and are associated with the propellers 15 can be closed by means of folding or sliding covers. These covers are closed when the airship is in the cruise configuration; they are opened only when the propellers 15 are being used to manoeuvre the airship and/or to assist the manoeuvring and/or trimming of the aircraft.

Adjacent to the respective trailing edge 19, the wings 8 to 11 each have upper blowing openings 20 for compressed air on their upper surface 16, and lower blowing openings 21 for compressed air on the lower surface 17. The blowing openings 20 and 21 are in this case in the form of blowing slots 22. These are each connected via compressed air channels 23 to a compressed air pipeline 24. A rotary slide valve 25 is arranged in the interior of each of the compressed air pipelines 24, by means of which the compressed air channels 23 associated with the upper blowing openings, or else the compressed air channels 23 associated with the lower blower openings 21, can selectively be closed.

The most recently explained devices in this case form components of a device by means of which aerodynamic lift is produced, which above a lower airspeed limit value, can be varied independently of this airspeed and independently of the pitch angle. If, as is shown in FIG. 4, compressed air is supplied to the upper blowing opening 20 by appropriately positioning the rotary slide valve 25, then the fluid flow 26 flowing around the wing aerofoil section is diverted downwards in the region of the trailing edge 19 of the wing, as a result of which the rear stagnation point (Kuttapoint) 27 moves forwards on the lower surface 17 of the wing. The airflow flowing around the wing is thus diverted in such a manner that an impulse force component directed downwards is produced. An upward lift force 28 acting on the relevant wing is produced, corresponding to this impulse force component. This takes place as soon as the airspeed, which corresponds to the speed of flight, exceeds a lower threshold value. This is largely independent of the wing incidence angle, but is dependent on the speed of the airflow flowing through the blowing slot 22, or the airflow rate being blown out.

FIG. 5 shows the corresponding relationships for a position of the rotary slide valve 25 in which compressed air is applied to the lower blowing opening 21. In corresponding use of what has been stated above, this results in a downward force 29.

Appropriate actuation of the blowing openings 20 and 21, respectively, provided on the front wings 8 and 9 and on the rear wings 10 and 11 not only allows the aerostatic lift of the airship to be increased or reduced—if they are actuated in the same direction—but also allows the airship pitch angle to be trimmed and/or its flying altitude to be controlled—by differential actuation, in particular in opposite directions. In this context, the wings 8 to 11 are arranged in tandem in such a way that the front wings 8 and 9 are arranged in front of the center of lift of the fuselage 1, and the rear wings 10 and 11 are arranged behind it, and this is a major advantage.

The flowchart in FIG. 6 shows the operation of a control system for influencing the flying altitude of the already described airship when the pilot operates a control device as a function of the instantaneous airspeed. An airspeed indicator 30 determines the speed of the airship relative to the surrounding air, that is to say the flow rate or the speed of flight (with respect to the air). The measured speed signal is supplied to two comparatives 31 and 32 in which the measured speed is compared with a lower threshold value and an upper threshold value, respectively. In the present case, that is to say with the large airship shown in FIGS. 1 to 5, the lower threshold value is 40 kkm/h and the upper threshold value is 70 km/h.

Depending on the measured speed, the control deflection of the control device 33 operated by the pilot is supplied to the devices 34 producing the vertical thrust, to the devices for influencing the flow around the wings 35, and to the elevator drive 36. If the airspeed is less than 40 km/h, then the airship is controlled via the vertical propellers 15. In a medium speed range between 40 and 70 km/h, the airship is controlled by appropriately influencing the flow around the wings 8 to 11. If, on the other hand, the airspeed is greater than 70 km/h, then the airship is controlled by appropriate deflection of the elevators 5. Obviously, although this is mentioned only for the sake of completeness, mixed methods of control are feasible if required.

FIG. 7 uses a flowchart to show how the pitch angle of the airship shown in FIGS. 1 to 5 can be trimmed at different speeds. If the pitch angle exceeds a predetermined threshold value of ±5° in this case, then the trimming is activated automatically. If the air speed is less than 40 km/h, then the trimming is carried out by using the vertical propellers 15. At speeds above 40 km/h, on the other hand, as described in detail further above, the flow conditions around the wings 8 to 11 are used to influence the trimming of the airship. In this case as well, the trimming can also be carried out by a combination of the two said methods.

1. Method for altitude control of airships in all the speed ranges which occur during operation, having the following features:
a) above a predetermined upper speed threshold value, the altitude of the airship is essentially controlled by at least one elevator (5);
b) in the range between the upper speed threshold value and a predetermined lower speed threshold value, the altitude of the airship is controlled by aerodynamic lift (28) or downward force (29) which can be varied independently of the airspeed and incidence angle and is produced by aerodynamic lifting bodies; and
c) below the lower speed threshold value, the altitude of the airship is controlled by means of devices (14) which produce vertically acting thrust.

2. Method according to claim 1,
characterized
in that the aerodynamic lift (28) or downward force (29) which is used for altitude control is produced from a number of aerodynamic lifting bodies on the airship, which are arranged distributed in the longitudinal direction.

3. Method according to claim 1 or 2,
characterized
in that the aerodynamic lift (28) or downward force (29) is produced by means of circulation control on at least one wing (8 to 11).

4. Method according to claim 1 or 2,
characterized
in that the aerodynamic lift (28) or downward force (29) is produced and varied by means of aerofoil section variation of at least one wing.

5. Method according to one of claims 1 to 4,
characterized
in that the pitch angle trimming is carried out by means of aerodynamic lift (28) or downward force (29) which can be varied independently of the airspeed and pitch angle.

6. Airship having a fuselage, with forward propulsion means and with aerodynamic lifting bodies for producing aerodynamic lift which, above a lower threshold value of the airspeed, can be varied independently of said airspeed and independently of the incidence angle, and can be influenced by means of a control device.

7. Airship according to claim 6,
characterized
in that the aerodynamic lifting bodies are in the form of at least one wing (8 to 11).

8. Airship according to claim 7,
characterized
in that said airship has a number of such wings (8 to 11) arranged offset with respect to one another in the longitudinal direction.

9. Airship according to claim 7 or claim 8,
characterized
in that the at least one wing (8 to 11) has blowing openings (20, 21) at the top and/or bottom in its rear aerofoil section region with respect to the airflow, which blowing openings (20, 21) are connected to a compressed air supply.

10. Airship according to one of claims 7 to 9,
characterized
in that the at least one wing (8 to 11) has suction openings for sucking away the boundary layer.

11. Airship according to one of claims 6 to 10,
characterized
in that a device (30) is provided for determining the airspeed, whose signal is supplied to a control unit which passes on the signals of a control device (33), as a function of the determined airspeed, to an elevator (5), to the aerodynamic lifting bodies which produce lift which can be varied independently of the airspeed and incidence angle, or to the devices (14) which produce vertical thrust.

12. Airship according to one of claims 7 to 11,
characterized
in that blowing openings (20, 21) and/or suction openings are arranged both on the lower surface (17) and on the upper surface (16) of the wings (8 to 11).

13. Airship according to one of claims 7 to 12,
characterized
in that the at least one wing (8 to 11) has associated installations for aerofoil section variation, such as leading-edge flaps (slats) or flaps.

14. Airship according to one of claims 7 to 13,
characterized
in that the devices (14) which produce the vertical thrust are in the form of propellers (15) integrated in the at least one wing (8 to 11).

15. Airship according to one of claims 7 to 14,
characterized
in that the at least one wing (8 to 11) has associated forward propulsion elements (12) such as propellers (13) acting in the longitudinal direction.

16. Airship according to claim 15,
characterized
in that the propellers (15) are arranged at the ends of the wings (8 to 11).

17. Airship according to one of claims 6 to 16,
characterized
in that, in order to reduce the induced drag at its end, the at least one wing (8 to 11) has associated winglets or comparable devices.

18. Method for pitch angle trimming of airships comprising the following features:
a) below a predetermined threshold value of the airspeed, the pitch angle trimming is carried out by means of devices (14) which produce vertical thrust;
b) above the threshold value of the airspeed, the pitch angle trimming is carried out by means of aerodynamic lift (28) or downward force (29) which can be varied independently of the airspeed and incidence angle and is produced on aerodynamic lifting bodies.
